(19) United States
(12) Patent Application Publication
(10) Pub. No.: US 2021/0019763 A1
(43) Pub. Date: Jan. 21, 2021

(54) A METHOD FOR MANAGING A VERIFIED DIGITAL IDENTITY

(71) Applicant: NEWBANKING APS, Copenhagen (DK)

(72) Inventors: Morten HELLES, Copenhagen (DK); Christian Visti LARSEN, Kongens Lyngby (DK)

(21) Appl. No.: 16/957,608

(22) PCT Filed: Dec. 19, 2018
(86) PCT No.: PCT/EP2018/085933

§ 371 Date: Jun. 24, 2020

(30) Foreign Application Priority Data
Dec. 27, 2017 (DK) PA201771026

(51) Int. Cl. G06Q 30/00; G06F 21/31; G06Q 50/26; G06Q 50/18; G06Q 10/10; G06F 16/23

(52) U.S. Cl. CPC G06Q 30/0185; G06F 21/31; G06Q 50/265; G06Q 50/18; G06Q 40/02; G06F 16/2379; G06Q 30/016; G06Q 2220/00; G06Q 10/10

(57) ABSTRACT

A method and a system for managing a verified digital identity of a user is disclosed. The method comprises receiving a verified digital identity for a user, the digital identity comprising user-data stored as data items; wherein each data item is certified as a verified data item. The method includes the following transactions: receiving a user-data consent from the user to enable one or more institutions, including a first institution, access to a selected group of the data items; receiving a user-data request from the first institution requesting access to user data from the digital identity, determining whether the first institution's request matches the user-data consent for enabling access to the selected group of data items, in accordance with a determination that the institution's user-data request matches the user-data consent for enabling access to the data items, granting the user data request, and providing access for the first institution to the selected group of data items.

### TECHNICAL FIELD

The present disclosure relates to systems, methods and computer program products for managing or handling user data. In particular the present disclosure relates to systems, methods and computer program products for the onboarding of individuals and entities or for providing a verified digital identity, including creating and maintaining a verified digital identity for a user, including a verified legal identity.

### BACKGROUND

Onboarding and maintaining personal information of current and potential customers or prospects is common practice as part of a Know Your Customer (KYC) process and many commercial institutions such as in the financial or insurance sector have developed their own platforms and systems. These require the prospect to supply for example personal data, identification documents, financial records, wage slips etc.

### SUMMARY

Currently, a potential customer or prospect must to send the required data and information for each new service required and to each company independently. Current onboarding procedures result in the prospect being required to send the same information to several different legal entities within the same organisation. Each different legal entity or institution requires a full and separate onboarding process. Current onboarding practices involve each separate legal entity collecting documents and face-to-face checking and/or individually engaging with reference agencies to verify customer identity against independent data sources. The customer must repeat the process of supplying data and information and wait on the legal entity to verify each piece of information. This process is then repeated for every institution and legal entity that the customer is or wishes to be engaged with and must personally keep an overview of what information is supplied to and stored with which institution. The process furthermore needs to be repeated when changes in personal information occurs to ensure that the data are updated as the current KYC and Anti Money Laundering (AML) regulations require each legal entity holds accurate, verified and up to date data on each of their customers.

Most documents contain a variety of different pieces of sensitive personal information. The KYC requirements may only be a proof of address and proof of employment but the wage slip provided contains many other irrelevant pieces of sensitive and confidential information. Or a requirement to provide a date of birth or age would mean that the customer's driving license number, address or passport number is also disclosed when it is not required.

The prospect may also have a desire to cease doing business with a company and would like their personal information supplied to and held by that company be destroyed or deleted. Current practice gives the customer no insight or guarantees that their desire to invoke “the right to be forgotten” has been carried out. Current practice is also burdensome for the institution to retrospectively trace the route and possible storage places for the data requested for deletion. At best the storage locations are known and each individual data copy must be manually deleted from multiple platforms. Often an institution has many separate formal and informal, independent and unlinked systems and platforms. Currently the customer has no control over their data and information once it has been supplied to an institution.

Sensitive personal information is often stored on a number of different platforms within an institution which are easily accessible to a variety of employees. This makes the information vulnerable to exploitation, misuse and not least unauthorised editing or tampering.

Legislation and regulations require that various items of customer information are always current and up to date. Therefore, a renewed passport or change of address requires that the process is repeated to update the out of date information. The institution must identify that a piece of information is out of date, it must then instruct the customer to supply and up to date version of the information, then on receiving the information it must verify it and update it's systems and discard all copies of the out of date information.

Current processes result in an individual who renews their passport having to update their information with multiple institutions. This is a cumbersome and time consuming process and is prone to error as an institution may not detect that some of the customer information is out of date.

A European Anti Money Laundering Directive, 4^{th} AML, came into effect in 2015. In 2018 a pan European General Data Protection Regulation, GDPR, will come into force. Both of these pieces of legislation increase the burden on commercial institutions to have a complete knowledge and control over customer personal data as well as unambiguous customer consent before sharing or processing their data.

Many current practices fall short of the coming regulations and/or are burdensome and non-transparent to the customer. They require a large number of resources for the institution to fully implement and ensure compliance.

Thus there is a need for more efficient systems and methods for managing, such as handling, user data in connection to e.g. onboarding procedures and when creating and maintaining verified digital identities. This is obtained by one or more embodiments described in this disclosure.

According to some embodiments, a method for managing a verified digital identity of a user is disclosed. The method comprises receiving a verified digital identity for a user, the digital identity comprising user-data stored as data items. Each data item may be certified as a verified data item. The method includes the following transactions: receiving a user-data consent from the user to enable one or more institutions, including a first institution, access to a selected group of the data items. The method comprises receiving a user-data request from the first institution requesting access to user data from the digital identity and determining whether the first institution's request matches the user-data consent for enabling access to the selected group of data items. The method comprises in accordance with a determination that the institution's user-data request matches the user-data consent for enabling access to the data items, granting the user data request, and providing access for the first institution to the selected group of data items. The method may further comprise in accordance with a determination that the institution's user-data request does not match the user-data consent for enabling access to the data items, not granting the user data request, and thereby not providing access for the first institution to the selected group of data items.

According to some embodiments, a system for managing a verified digital identity of a user is provided. The system comprises a client terminal, such as a user interface, a processor, such as a hardware processor and a storage medium, such as a computer readable storage medium, such as a cloud based storage medium, such as an internet accessible storage medium, such as a server based storage medium. The storage medium is configured to store, and may store, a verified digital identity for a user, the digital identity comprising user-data stored as data items; wherein each data item is certified as a verified data item, and user-data consents. The system further comprises a computer program product comprising instructions which when executed by the processor, such as the hardware processor: receiving a user-data consent from the user to enable one or more institutions, including a first institution, access to a selected group of the data items; receiving a user-data request from the first institution requesting access to user data from the digital identity, determining whether the first institution's request matches the user-data consent for enabling access to the selected group of data items. In accordance with a determination that the institution's user-data request matches the user-data consent for enabling access to the data items, granting the user data request, and providing access for the first institution to the selected group of data items. In accordance with a determination that the institution's user-data request does not match the user-data consent for enabling access to the data items, not granting the user data request, and thereby not providing access for the first institution to the selected group of data items.

According to some embodiments, a method for managing, such as for handling, user-data stored in a user's digital identity is provided. The method comprises: receiving a digital identity for a user, wherein the digital identity may comprises user-data stored as data items. The method comprises receiving a consent from the user to enable an institution access to a selected group of the data items and receiving a request, such as a user-data request, from the institution to access the selected group of data items from the digital identify. The method further comprises determining whether the institution's request matches the user consent for the data items. If the consent to the permission is given, then the user-data request may be granted. If the consent to the permission is given then the request from the institution may be granted.

In some embodiments, a system for managing, such as handling, user data is provided. The system comprises: a client terminal; a processor, such as a hardware processor; a computer readable storage medium storing: received digital identities comprising user-data stored as data items, user-data permission consents; and a computer program product comprising instructions. The computer program product may comprise instructions which when executed by the hardware processor provides a digital tool for: receiving a user-data request for access to individual user-data items, determining whether the user-data request matches the user-data permission consent for the data items. The instructions may furthermore enable access to one or more user-data items corresponding to a received user-data request where consent to the user permission.

In some embodiments, a method of handling user data comprises a client terminal; a processor, such as a hardware processor; and a computer readable storage medium configured to: store received user data as data items, store user data permissions; store a computer program product comprising instructions for providing a digital tool. The instructions may when executed by the processor provide a digital tool for receiving customer request for access to individual user data items, comparing the customer data request to the user data permissions, enabling access to one or more user data items corresponding to a received customer data request where user permission is granted, and creating a record of each data transaction.

The terms “user”, “customer” and “prospect” are used interchangeably. More specifically a prospect is a potential customer of an institution. The customer is an existing customer of an institution and a user can be either a customer or a prospect. In the following embodiments a user, customer or prospect can be an individual person, a society, a company or any entity that could have a legal identity.

The term “institution” can be understood to mean any entity who has subscribed to the method and system as described who would place a request for access to data of a user. Generally this would be any commercial or non-commercial institution who have potential customers and/or existing customers and who require unique individual information to register the customer as a user. This could be but is not limited to financial institutions, insurance companies, legal service providers, betting companies. Most commonly, any entity who wishes to onboard a prospect or manage the data access of a customer and ensure the customer has a verified digital identity.

A “provenance enabling system” is a system that provides data provenance and is central to the validation of data. A known provenance enabling system is the blockchain technology. The data can be a hash of the original data or any number of hashes.

Encrypted data is preferably encrypted to at least a banking grade level, 256-bit AES encryption or similar standard.

The terms “grant” and “consent” are used interchangeably and are synonymous with each other in the context of this document. A permission may be granted to data which has the same meaning as a consent is given for permission to the data.

A “permission” can be understood in that a permission to the data is the same as access to the data. A permission may be granted where access to the data is given, or a permission may be revoked, it which case access to the data is either not given or existing access is removed.

The term “transaction” refers to an operation to access data. This may be reading data, writing or both. Examples are submissions of data, data verification requests, data verification responses, consent of permission, revocation of consent of permission, deletion of consent of permission, request for data and so on.

The disclosed method, system and computer system has a number of advantages over the prior art in that it provides the customer with:
a simple and auditable method to revoke permissions of individual data items,
a single place to display an overview of granted or consented permissions, revoked permissions and permission status', information is centralized,
security by design (encrypted data communication and storage),
privacy by design,
a transparent and simple way to request the right to be forgotten,
ownership of customer or user data, such as customer personal data
a user account that can be used multiple times as a legal identity, and
an improved and augmented user experience.

It further provides the institution with:
a simple method of onboarding prospects,
a simple method of maintaining user data, such as personal data, for prospects and customers
a method of managing user data,
a method of managing digital identities
a method of managing verified digital legal identities
the elimination of redundant compliance checks,
irrefutably verified data items,
a single point of access of prospect and customer data permission status,
security by design (encrypted data communication and storage),
privacy by design,
a means to externalise the customer data responsibility. This reduces the risk of a substantial penalty due to lack of compliance with regulatory requirements, and
an ability to always securely access and handle data required with user permission consents.

The method and system also provides a regulatory third party trusted, transparent, auditable and irrefutable access to data transaction history, consented permissions, revoked permissions and permissions.

The method and system requires only one submission of each piece of valid data and/or information for each user. This reduces the burden and effort required by a user to become a customer with multiple institutions.

The method and system requires only one verification of each piece of user data and/or information. This reduces the time taken to onboard a prospect for an institution as any information previously supplied by the user will have been verified prior to the onboarding by that particular institution. The elimination of subsequent verification steps by the institution will also have the advantage of reducing the cost of processing and purchasing an additional verification by a third party.

The elimination of a verification step by the institution will also have the advantage of reducing the number of external company interfaces, data transactions and unnecessary exposure of sensitive customer data.

Some data and/or information categories will be required to be resubmitted when the data and/or information of the original submission has expired or is no longer correct. For example when a passport, driving license or identity document has expired and been renewed or if there is a change of address. It should be noted that an update of information will require the re-verification of the information and the customer to actively re-consent the permission to the institution.

The method and system ensures a standardised practice of verification, data storage, data transaction history logging and onboarding. This enables regulatory bodies to quickly and efficiently assess the customer data protection compliance of institutions and reduces the need to investigate and test every internal procedure for each individual institution.

In some embodiments, the method and system as disclosed enables a user to manage, including creating and/or maintaining, a user owned and controlled verified digital identity. The verified digital identity may be created and maintained by a user. The verified digital identity may be accessible for one or more institutions. In some embodiments, elements of the verified digital identity can be reused to manage verified digital identities for a plurality of institutions, including a first institution.

This is done in a way where each data transaction is logged and recorded by a provenance enabling system. The verified digital identity can be replicated any number of times and combined with any other combinations of data and stored to a provenance enabling system and attached to any transaction as an irrefutable certificate including personal identification data. All of this is encrypted and so there is a highly reduced risk to the misuse of any personal data. The user has a simple and single overview of which entities and institutions have access to what personal information and can revoke this access at any time.

In some embodiments, a record of each data transaction is recorded or maintained. For that purpose, the computer program product may comprise instructions for storing a record of each data transaction on the computer readable storage medium.

In some embodiments, the transactions include user-data consent, user-data request, determination on requests, grant of user-data request and access provided for each of the one or more institutions, including the first institution, etc.

In some embodiments, a record of each transaction is maintained. Each transaction may be of a transaction type selected from the group of the following transaction types: user-data consent, grant of access, revocation of consents, deletion of consents, requests for deletion, request for user-data, request for verification of data, request for access, deletion, response of verification of data, re-sharing of data, user-data verification response. The transaction type may furthermore comprise any other transaction type, such as any other transaction type described herein.

In some embodiments, the selected group of data items are determined based on the transaction type. A hash value may be determined for the selected group of data items. The method further comprises storing the hash value of the selected group of data items with the transaction record.

This ensures that the data is secure and has a degree of encryption.

In some embodiments, a record of each transaction is stored in the computer readable storage medium, each transaction being of a transaction type selected from the group of the following transaction types: user-data consent, grant of access, revocation of consents, deletion of consents, requests for deletion, request for user-data, request for verification of data, request for access, deletion, response of verification of data, re-sharing of data.

In some embodiments, the selected group of data items may be determined based on the transaction type and wherein a hash value is determined for the selected group of data items are stored with the selected group of data items with the transaction record, such as forming part of the transaction record.

In some embodiments, the data transaction record is written to a provenance enabling system.

This makes the location and status of all data transparent, secure and tamper proof. This system is fully and easily auditable and any request for revocation of data consents can occur automatically and is logged. Each transaction including data requests, verifications and other transactions may be recorded to the provenance enabling system. This ensures that there is an irrefutable record of each data transaction which can be used retrospectively in an audit scenario.

In some embodiments the provenance enabling system is replicated and/or distributed amongst participating institutions. Due to the encrypted nature of the information on the provenance enabling system only an institution granted data permissions has access to the corresponding piece of data. The institution may gain access to user permission consented data via a widget or an application programming interface (API).

In some embodiments, the provenance enabling system is a blockchain, such as a private blockchain distributed among trusted partners.

In some embodiments, a request for revocation of at least a part of the user-data consent is received from a user, and in response to receiving such a request revoking access to a corresponding part of data items. In some embodiments, at least some of the user data permissions may be revoked by the user and corresponding user data may be withdrawn. It is an advantage of the disclosed systems and methods that a user can revoke a consented permission such that institutions using the disclosed systems and methods for managing, such as handling, user data does not violate official regulations.

In some embodiments, the user-data consent is institution and data item specific, and the selected group of data items may be selected for each of the one or more institutions or for each group of the one or more institutions. In some embodiments, the user data permissions are customer and data item specific.

In some embodiments, the user-data consent is a time limited consent, and wherein grant of access is automatically revoked upon expiry of the time limited consent. The user may for example give a time limited user-data consent, such a user-data consent having an expiry date, and the user-data consent may then be available up to the expiry date, such as for a period of time ending at the expiry date.

In some embodiments, a request from the user to withdraw a user-data consent is received and in response to receiving the request, the consent may be withdrawn either immediately or upon approval of the request to withdraw the user-data consent. For example, a financial institution will have to provide a consent for withdrawal due to financial regulations requiring the financial institutions to keep data for period of time after a user-institution relationship is ended.

In some embodiments, the verified digital identity is a verified digital legal identity.

It is an advantage that the user can control which user-data, such as which personal data are shared with a given institution (or customer). This provides that the user has better control over his user-data, such as his personal data, and the time period during which these user-data are shared.

In some embodiments the verified digital identity may comprise data item legal confirmations and/or data item legal proofs, the data item legal confirmations and/or the data item legal proofs including certification that required data item verification processes have been performed.

In some embodiments, the method comprises a verification of the user data by sending a request for verification of the received user data and receiving a verification of the received user data. This provides the advantage for the institution that the risk for fraud is being reduced. Such verification can be implemented by a computer program product comprising instructions for verifying the user data by sending a request for a verification of the received user data and receiving a verification of the received user data. The received verification may be stored on the same computer readable storage medium on which the computer program product is stored.

The disclosed computer program product may comprise instructions which when executed by a hardware processor provides a digital tool configured to perform the steps of the disclosed embodiments of the method.

In some embodiments, the computer program product comprises instructions for receiving an input indicating that the user data permissions should be revoked and in response to receiving the instruction withdrawing the user data.

In some embodiments managing a verified digital identity of a user comprises receiving from the user additional user data. The additional user data may be stored as new verified data items. The additional user data may be stored as updated verified data items replacing previous verified data items. The additional user data may be corrected user data replacing previous data items stored but not certified as verified data items.

In some embodiments, the additional user data are the first user data uploaded to create the verified digital identity.

In some embodiments, in response to receiving additional user data, the additional user data are processed for verification. In accordance with a determination that the additional user data can be certified as verified user data, the verified user data are stored as verified data items. The verified user data may be stored on the computer readable storage medium.

In some embodiments, processing the additional user data for verification comprises sending a request for verification of the additional user data and obtaining verification of the user data. In some embodiments, the request for verification of the additional user data and the verification of user data is obtained from a third party verification service company.

In some embodiments, the verification of the user data is carried out by a third party.

This ensures the verification process can be externalised to an institution which meets the regulatory requirements and standards and specialise in verification.

In some embodiments, the computer program product may comprise instructions received from the user, the instructions comprising a request for revocation of at least a part of the user-data consent, and the computer program product may further comprise instructions for revoking access to a corresponding part of data items.

In some embodiments, the computer program product may comprise instructions for processing additional user data for verification, the instructions comprises sending a request for verification of the additional user data, obtaining verification of the user data, and storing the obtained verification of user data on the computer readable medium.

In some embodiments, the one or more institutions may provide access to a web interface for the user, and wherein the web interface enables the user to manage the verified digital identity of the user including providing consent to user-data and uploading of user data, including additional user data.

The web interface may be a web interface of the one or more institutions, or the web interface may be a web interface module for integration with a web interface of the one or more institutions. The user may access the web interface via a client terminal, such as via any user interface for the web interface.

In some embodiments, the verified digital identity is used in a cryptocurrency transaction and the verified digital identity or selected data items of the verified digital identity is used as proof of identity for the cryptocurrency transaction. In some embodiments, only the hash value of the verified digital identity or of the selected data items of the verified digital identity is recorded with the transaction.

Disclosed is a method for managing verified digital identities, including onboarding users, creating a verified digital identity, maintaining a verified digital identity, etc. The method comprises managing or handling user data by a method according to one of the disclosed embodiments. The outlined method and system can be used to output a transaction-specific unique legal identification for use in cryptocurrency transactions. The unique legal identification may be the verified digital identity or selected data items of the verified digital identity. One of the issues holding back the adoption of current cryptocurrencies such as Bitcoin and Ethereum by mainstream financial institutions is the difficulty in having an easily traceable and registered transaction history as required by current financial regulations. In some embodiments a customer having a verified digital identity as disclosed herein can make a cryptocurrency transaction. The transaction enabler will then request the customer's digital legal identity which will be supplied. This unique identifier can contain identification information as well as transaction details, date, time, IP address etc. and may be stored on the ledger connected with the cryptocurrency.

In some embodiments, managing a verified digital identity of a user comprises receiving from the user a request for deletion or amendment of a data item, and wherein in accordance with a determination that the data item does not form part of a selected group of data items for which grant of access has been provided, fulfil the request, and in accordance with a determination that the data item forms part of a selected group of data items for which grant of access has been provided, deny the request.

In some embodiments, the method comprises upon receiving a user-data consent from the user and providing access for the first institution to the selected group of data, enabling the first institution to re-share at least a part of the selected group of data to further institutions. The first institution may thus share the user-data items with one or more further institutions. Typically, any user agreements of the first institution will ensure consent from the user upon receipt of any initial user-data consent. As an example, a real estate agent may re-share user-data or parts thereof with lawyers, financial institutions, insurance companies, etc.

The outlined method and system can be used to output a transaction-specific unique legal identity, such as a verified digital identity, such as a verified legal identity, for use in any transaction. The transaction may be legal documents, deeds, last will and testament, financial, cryptocurrency.

The transaction enabler will then request the customer's verified digital identity which will be supplied. This verified digital identity, such as a unique identifier, can contain identification information as well as transaction details, date, time, IP address etc. and may be stored on the ledger connected with the transaction. The identification stamp is fully auditable and an irrefutable source of truth. The advantage of the system is that the customer may only have to input the identification information once. This may already be done in connection with setting up a bank account or opening a betting account. This information can be requested by any number of users and once the customer gives a permission consent the digital legal identity certificate or stamp can be used in connection with the transaction.

In some embodiments a user a) selects the data to share, b) identifies the length of time to allow access to the data (e.g. 7 days), c) creates an optional password to protect the personal data being shared, d) identifies the recipient/institution allowed access to the data (for example by way of an email address), and e) triggers the system to send a communication to the recipient(s) indicating personal data is available to be accessed. The recipient/institution can then then access the personal data for example by clicking a link in the received communication and using the password to gain access until the predetermined expiry date.

In some embodiments, the system is configured to receive the user data via a user interface displayed on the client terminal. In some embodiments, the client terminal is a user interface providing access to the system and method.—

In some embodiments, the user uploads the user data.

Disclosed is a method for creating a verified legal identity, wherein the method comprises managing or handling user data by a method according to one of the disclosed embodiments.

In some embodiments a computer readable storage medium receives customer data via a direct user interface or user interface embedded in the institution's user interface connected to an Application Programming Interface API.

Other features, embodiments and advantages will be described below in the detailed description.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 shows a typical process used by institutions presently,

FIG. 2 shows an embodiment for a new and improved process or method for managing user data,

FIG. 3 shows a flow diagram illustrating an embodiment,

FIG. 4 shows the data import sequence part of a method according to some embodiments,

FIG. 5 shows the permission consent sequence of a method according to some embodiments,

FIG. 6 shows the revoke permission consent sequence of a method according to some embodiments.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

### EXAMPLES

In some embodiments, a method for managing or handling user-data is disclosed, the method may comprise;
receiving user-data;
creating a digital identity for the user, the digital identity comprising the received user-data as data items;
storing the digital identity on a database—receiving a user-data permission consent from the user to enable an institution access to one or more of the data items of the digital identity, and updating a consent status for the user-data permission;
receiving a user-data request from the institution to access the one or more user-data items,
comparing the user-data request to the consent status, and
if the user-data request and the consent status match then the user-data request is granted.

In some embodiments, a system managing or handling user data is disclosed. The system may comprise:
a client terminal;
hardware processor;
a computer readable storage medium configured to:

storing received user data as data items,

storing user data permissions;

storing a computer program product comprising instructions which when executed by the hardware processor provides a digital tool for:

receiving customer request for access to individual user data items,

comparing the customer data request to the user data permissions,

enabling access to one or more user data items corresponding to a received customer data request where user permission is granted, and

creating a record of each data transaction.

In some embodiments, the received customer data may be stored on a computer readable storage medium and logged by a provenance enabled system.

The customer data may be verified and the verification certificates or logs are stored. The verification process can take many forms and should not be limited to the following examples. A passport verification may be verified by a dedicated third party such as Gemalto and an email may be verified by sending a verification link to the inputted email address. The verification step and result are stored on a computer readable storage medium and may be recorded to a provenance enabling system such as blockchain. The record may in turn be a hash of the data stored or any number of hashes.

Each data verification is stored on a computer readable storage medium and may be recorded on a provenance enabling system. Alternatively all data verifications can be completed and the final combined verification process may be recorded to a provenance enabled system. The method and system provides the institution with irrefutably verified data items that have been requested and where the user permissions allow access.

The stored customer data may be viewed by the customer at any time via the user's unique user account and via a user interface.

The possibility to assign a permission consent to each item of data is presented to the customer. The customer may assign one or any number of institutions permissions to allow access to the customer information. The assigned permission consents are logged and recorded to a provenance enabling system and stored on a computer readable storage medium.

The institution may contact the customer and outline the user permission consents to be assigned to enable a digital legal identity to be created. The requirements for a digital legal identity may be different depending on the service or function required. For example the requirements for opening a bank account might require user permission consents for 10 pieces of customer data whereas the requirements for taking out travel insurance might only require user permission consents for 5 pieces of customer data.

The API receives a request from an institution to gain access to one or more of unique pieces of data or information for a unique and individual customer. This request is stored on a computer readable storage medium and logged and recorded to a provenance enabling system.

The request for user data items A, B and C is compared against the user permission consent status for user data items A, B and C for the specific institution requesting. Only the data which the institution requested and which the user has also given a permission consent for will be supplied to the institution. This data transaction is stored on a computer readable storage medium and logged and recorded to a provenance enabling system.

The API may also receive a revocation request from the user for one or more of the data permission consents for one or more institutions. In this example the consented data permissions for the one or more pieces of user data are rescinded and if there are no contractual obligations between the customer and the institution then no future access to the selected data by the selected institution can be achieved until the user consents the necessary permissions again. If there is a contractual obligation between the customer and the institution then the consent is valid for the period of the remaining contract timescale and rescinded when the contract expires or is terminated. The status of data and/or information consent revocation will be pending until the contract expires or is legally terminated. For example if a customer is still a customer with a financial institution then the consents are consented even if the customer revokes the consented permission. It is a legal requirement that the institution has access to the legal identity information of their customers and this will be stated in the contract between the customer and the financial institution. The customer must terminate the contract with the financial institution and remove their custom. Then all pending revoked permissions will be actioned and the financial institution will not have the required consent to the permissions for the data.

In addition the institution is notified of the user data rescinded to enable them to take the necessary actions with their internal systems. This data rescindment is stored on a computer readable storage medium and logged and recorded to a provenance enabling system.

In some embodiments the provenance enabling system is distributed amongst participating institutions. Due to the encrypted nature of the information on the provenance enabling system only an institution granted data permissions has access to the corresponding piece of data.

In some embodiments the institution may gain access to consented user data via a widget.

The method and system provides a single source of truth and irrefutable log of data permissions and transactions. The provenance enabling system provides an irrefutable log of all data transactions, requests and permissions and a single point of reference for any regulatory body wishing to audit transactions linked to one or more individual users or one or more individual institutions. This ensures full transparency and saves a substantial amount of time, money and man hours normally required to compile the relevant information to be submitted for audit.

In some embodiments the customer may request a data permission consent for an institution not linked or subscribed to the system. The system will generate a means for electronic access to the requested data and a security means. This could be with an encrypted file or a locked link that the customer can share with the institution. The system will also generate a means for unlocking the data and this is sent to the customer who can then share this with the institution. The customer is able to set a time limit on the length of time that the institution has access to the shared data.

In some embodiments of the invention an institution receives a request from a prospect that the prospect would like to become a user or customer. The institution requires that the prospect fulfils a set of predefined requirements to create a legal identity.

The institution notifies the prospect of the information or data required. The institution then sends a request to the API for access to the same information as the prospect was notified of. The institution receives any information that has been requested and also has a data specific user consented permission for the requesting institution.

The institution can see the status of the information verification and has a possibility to use their internal verification process if required or accept the verification stored on the system computer readable storage medium and logged and recorded to the provenance enabling system.

A change in regulations or legal requirements for the identification of customers would prompt the institution to send a notification to the customer to update the information or to grant a new permission for the information or data required. The institution would then submit a data request to the API which would be cross referenced against the customer chosen data permissions. The data would only be released to the institution if the institution data request matches the customer chosen consented data permission.

The permission consent can expire automatically after a predetermined period of time. A prospect may have given permission consents to an institution but then not become a customer for one reason or another. The consents could then auto expire after a predetermined period, for example after 90 days. The same functionality could be implemented for customers where the predetermined time limit may be set to a different value. Any value that complies with AML and data protection regulations.

The institution has a single point of contact for all of the user data and information and access to a log of the customer data transaction history. This ensures that the data history of a customer is independent of an individual employee or geographical location. The institution can ensure a single standard of verification across teams and geographical locations. The institution will be required by current and future legislation to ensure and provide proof that a customer's data has been deleted. The logs on the provenance enabling system ensure that all customer data transactions have been registered, mapped and accounted for. The institution may prefer that the customer data is stored within the present system by the independent third party providing the system, such as the system for managing a verified digital identity for a user. Any revocation of customer permissions can then be instantaneous and fully compliant.

In some embodiments of the invention the institution is not linked to the customer data permission system. In this embodiment the institution will request customer data and information items from the customer. The institution will receive an electronic means for accessing the requested customer information. The electronic means can be an encrypted file or a link to the customer data consent system. The institution will also receive a key to enable secure access to the requested data.

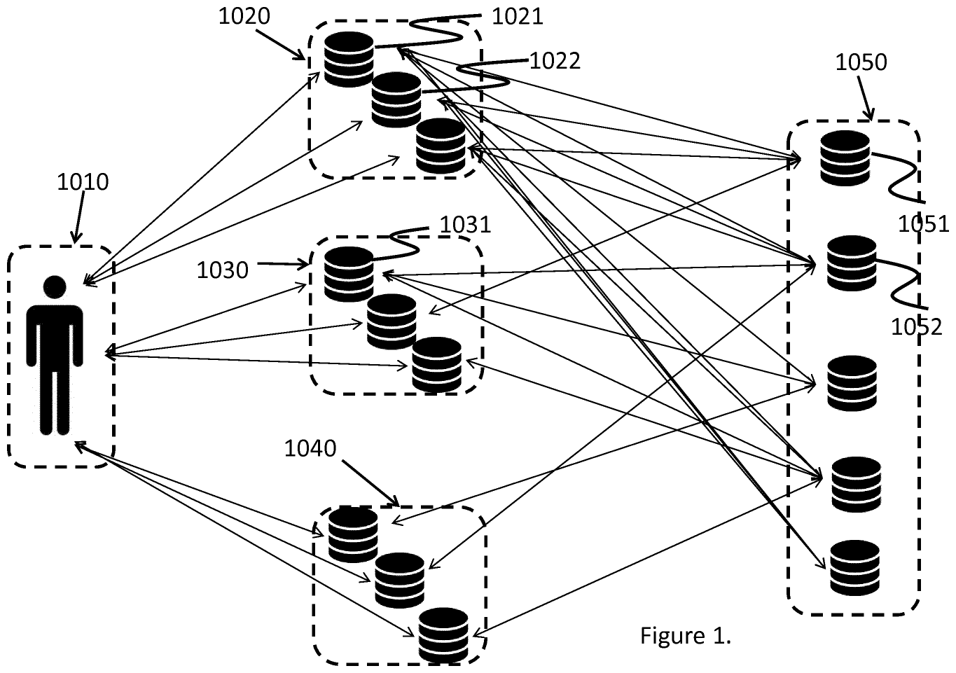

FIG. 1 shows an embodiment of the present disclosure in which a user 1010, such as a private user 1010, uses the method of managing verified digital identities to obtain a personal verification when communicating with an institution 1020, 1030, 1040, for example for setting up a bank account with a financial institution 1020, an insurance policy with an insurance provider 1030, book an airline ticket or become a customer with a merchant 1040. FIG. 1 shows that the customer 1010 has to engage with each institution 1020, 1030, 1040 individually. The required documents 1051, 1052 which must be sent or provided to each individual financial institution 1021, 1022 or merchant 1040 and each individual institution 1021,1022, 1031 must then verify each piece of information 1050 and each document 1050 according to their internal policies and procedures. In some instances the same documentation 1050 is required to be sent by the customer 1010 to different legal entities 1021, 1022, 1031 within the same company e.g. as a legal requirement. For example an insurance provider 1031 may also be a financial institution 1021.

In another example of current market practice a customer's information 1050 might be shared internally between departments and affiliated companies 1021, 1022, 1031 without the knowledge or consent of the customer 1010. The customer 1010 might not want to have information 1050 like e.g. current salary 1051 or tax reports 1052 shared with departments that could use the information to target products or adverts at the customer.

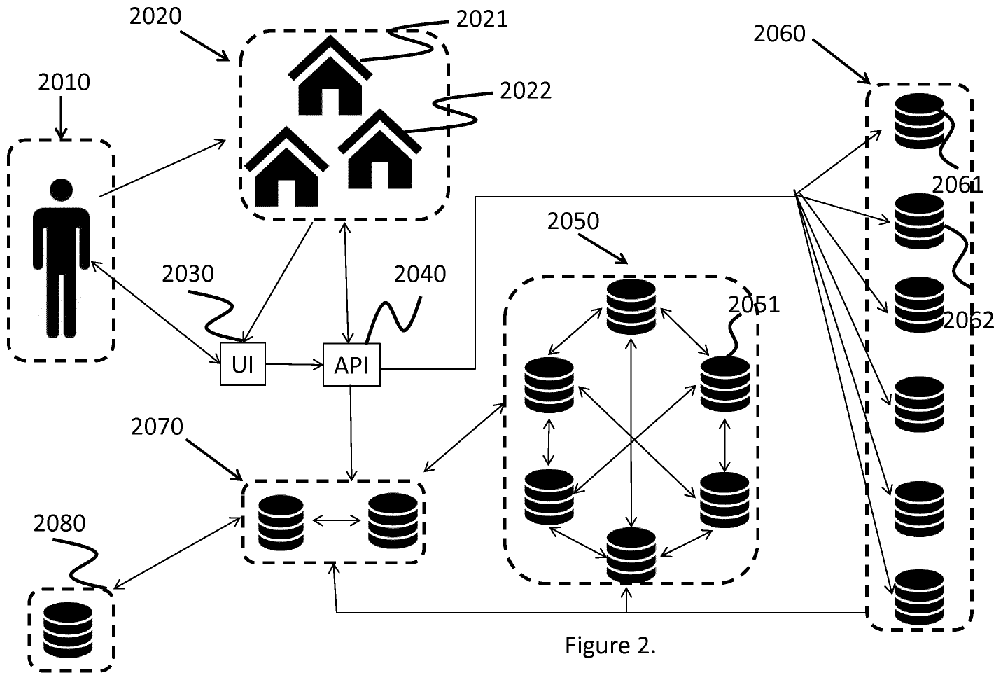

FIG. 2 shows another embodiment of the present disclosure where the user or customer 2010, such as private user or private customer 2010, enters their details and documents via a web interface of the institution or in another preferred embodiment via a direct user interface (UI) 2030. The details and documents are transferred as data items via an application programming interface (API) 2040 and stored, e.g. on a computer readable storage medium 2070, such as on a server, on a cloud based storage, etc., as well as logged and recorded to a provenance enabled system 2050.

The data items are verified by verification process 2060 in various ways. The verification process may generate a verification certificate, and the verification certificates are stored, e.g. on the computer readable storage medium 2070, as well as logged and recorded to a provenance enabled system 2050. The verification process 2060 can take many forms and may depend on the data type, legal requirements or institution preference and should not be limited to the following examples. A passport verification 2061 may be verified by a dedicated third party system such as “Gemalto” and an email 2062 may be verified by sending a verification link to the inputted email address. The verification step and result is recorded and written to a provenance enabling system 2050 such as blockchain. The record may in turn be a hash of the data stored or any number of hashes.

Each data verification 2060 is stored on a computer readable storage medium 2070 and recorded on a provenance enabling system 2050. Alternatively all data verifications can be completed and the final combined verification process may be recorded to a provenance enabled system 2050. The method and system provides the individual institutions 2020 with irrefutably verified data items that have been requested and where the user permission consents allow access.

The customer 2010 can view the data stored at any time via the user interface 2030. Typically, the costumer 2010 will have access to a user account, such as a unique user account, via the user interface 2030. The customer 2010 can chose which institutions 2020 have access to which items of data from their unique user account. The same data can be supplied to multiple institutions 2021, 2022 depending on the user permission consents present for the data items and the data requested by the institution. The method and system provides the customer 2010 with a single point of access and control of personal data access for multiple institutions 2021,2022. The single point of access and control may be through the user account.

The institution will not receive or have access to any customer or user information that it has not requested and which also has not been approved or given a permission for by the customer or user.

The reverse also applies and the user may choose to revoke the permission for individual data items for individual institutions. The method and system provides the customer with a simple and auditable method to revoke institution access to data items, such as to individual data items.

The institution may send a request for pieces of information, such as specific data items, and will be granted access to only those where the user has given that institution consent.

Each data request, verification and transaction is recorded to provenance enabling system.

In some embodiments the provenance enabling system is replicated and/or distributed 2051 amongst all or some of the participating institutions 2021. Due to the encrypted nature of the information on the provenance enabling system only a specific institution granted a data permission has access to the respective piece of data. The institution can gain access to user consented permission data via a widget or via an API.

The method and system provides a single source of truth and irrefutable log of data consents and transactions. The method and system provides the customer with a single point of control, contact and access for multiple interfaces with multiple institutions. The method and system provides the customer with an overview of permissions granted and permissions revoked. The method and system enables the customer to only have to provide data and information once. The method and system enables the customer to use the verified data for multiple institutions on multiple times.

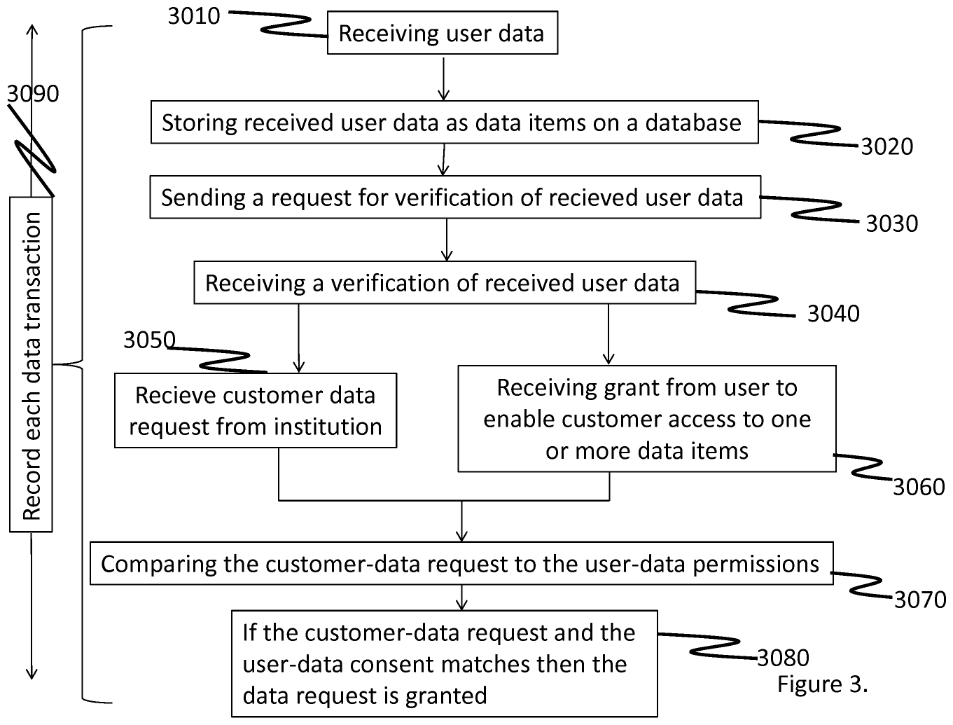

FIG. 3 shows the implementation of the method in the system. The system receives user data 3010, and stores the received user data as data items on a database 3020. The system sends a request for verification of the received user data 3030. This can be done in a number of ways, passport information may be sent to an independent third party verification service company such as Gemalto, an email address may be verified by sending an email to the user provided email address with a verification link, likewise a telephone number may be verified by sending an SMS to the user provided phone number with a verification link. These verification methods are common practice and the system is not limited to using them. When the user data is verified it will be transmitted and received by the system 3040. The system will receive a request for access to specific data items of user data 3050, and the data items required have been communicated to the user prior to or during a request for data received from an institution, e.g. prior to the onboarding process or as part of it, or as part of the method for managing the verified digital identity of a user. The system will also receive a permission consent request from the user to allow individual items of data to be shared with the selected institution 3060. The system will compare the user data request from the institution with the user defined permission for the selected data item and institution 3070. If both the institution and data item match for the institution data request and the user defined permission consent then the data will become available to the institution 3080. If the user consents permissions to data items that the institution does not request them the institution will not gain access to them until the institution sends a data request for that specific data item. If the institution sends a data request for a specific data item and the user does not consent, the permission to that specific data item and the requesting institution then the institution will not have access to the specific data item.

Each and every data request and transmission is recorded and logged on a provenance enabling system as well as stored to a database.

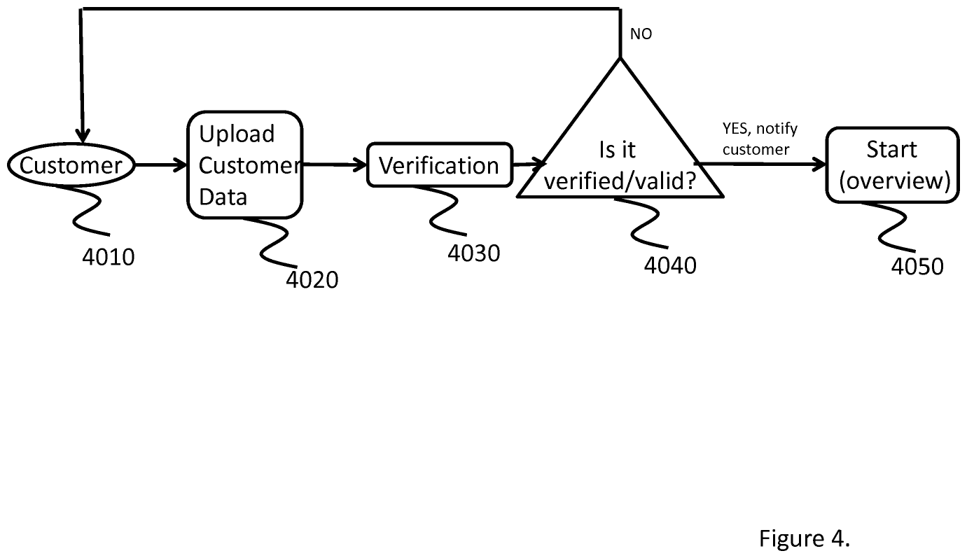

FIG. 4 shows a method or process for the verification of data during management of the verified digital identity, for example during onboarding, when adding additional customer or user data, or when updating existing customer or user data. The customer or user 4010, processed for verification 4030 and the method will determine whether the customer data is valid and can be certified as verified 4040. If the user data cannot be certified as verified, the customer 4010 may be asked to submit the user data again, e.g. if a user data submitted to the system was corrupted or unreadable or possibly out of date. This could apply if e.g. a copy of a document, such as a copy of a passport, was corrupted or unreadable or possibly out of date. If the user data is positively verified then the customer 4010 is notified and the user data is visible to the customer 4010 as an overview 4050 of verified user data (including user data that has been certified as verified) via a user interface connected to an API. This method or process is repeated for each item of user data and a full overview of all verified data items is available to the user 4010 as an overview 4050 of verified data via a user interface connected to an API.

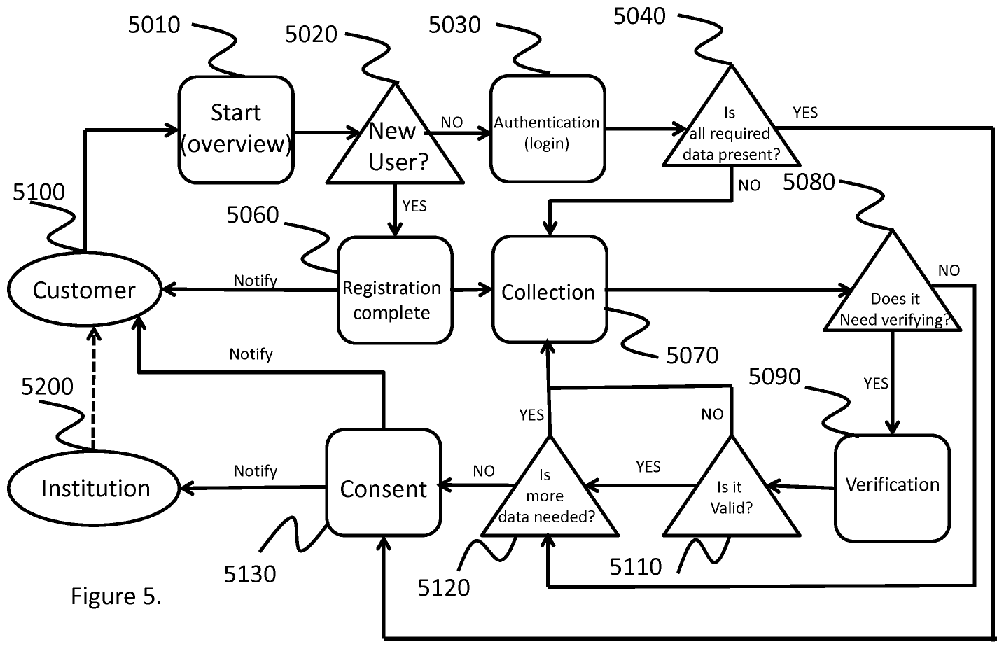

FIG. 5 shows a method or process for the consent of data permissions. The customer or user 5100 has potentially an overview 5010 of verified data, such as verified data items, via a user interface connected to an API. The customer must first create an account 5060 or log in 5030. If the user is new to the system then a process or method similar to FIG. 4 is carried out. The user data is collected 5070 and it is determined if it requires verification 5080. If the user data required verification then it is processed for verification 5090 and a determination of it's validity is made 5110. If it is valid then the system will determine if more data is required 5120, perhaps an institution has put in a number of data requests still not fulfilled or perhaps there is a minimum level of data required. If the data is not valid then the user will be asked to provide the data again 5070 or a new and correct version or the required data.

For existing users an authentication or login step is required 5030 and the data collection process is repeated 5040. If all of the required user data is collected and verified for both a new and an existing user then the user may issue a consent for a permission 5130 for each specific data item and specify for which institutions the consent is valid for. Both the customer 5100 and the institution 5200 are notified. The institution 5200 may wish to send a consent request to the customer 5200, this new consent request would initiate the process or method to begin again.

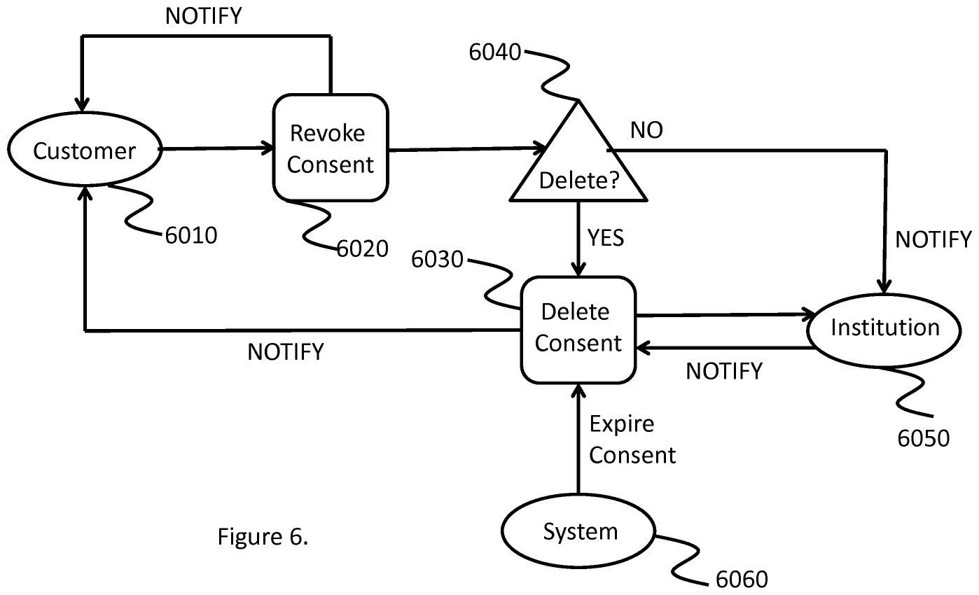

FIG. 6 shows a process or method for the revocation of a permission. The customer 6010 via a user interface connected to an API can make a request to revoke any permission 6020. The revocation of the permission could include the deletion of the permission 6030 or could include a request to revoke which is sent to the institution 6050. In either scenario the institution 6050 is notified. Some permissions are bound contractually and cannot be deleted until the contract has expired. This request for revocation is stored in the system 6060 until the contact expires. The request for revocation of consent of a permission is then actioned and the permission deleted 6030. For example if the customer is still a customer at a financial institution the customer cannot revoke all permissions. The customer is bound by a contract and the financial institution is bound by regulations to ensure they have a certain amount of valid information about the customer. If the customer wishes to revoke all permissions then they should close their account and end the contract. When this is done then all permissions will be revoked and deleted.

1. A method for managing a verified digital identity of a user, the method comprising;
receiving a verified digital identity for a user, the digital identity comprising user-data stored as data items; wherein each data item is certified as a verified data item,
the method including the following transactions:
receiving a user-data consent from the user to enable one or more institutions, including a first institution, access to a selected group of the data items;
receiving a user-data request from the first institution requesting access to user data from the digital identity,
determining whether the first institution's request matches the user-data consent for enabling access to the selected group of data items,
in accordance with a determination that the institution's user-data request matches the user-data consent for enabling access to the data items, granting the user data request, and
providing access for the first institution to the selected group of data items.

2. A method according to claim 1, wherein transactions include user-data consent, user-data request, determination on requests, grant of user-data request and access provided for each of the one or more institutions, including the first institution.

3. A method according to claim 1 or 2, further comprising maintaining a record of each transaction, each transaction being of a transaction type selected from the group of the following transaction types: user-data consent, grant of access, revocation of consents, deletion of consents, requests for deletion, request for user-data, request for verification of data, request for access, deletion, response of verification of data, re-sharing of data.

4. A method according to claim 3, wherein the selected group of data items are determined based on the transaction type and wherein a hash value is determined for the selected group of data items; the method further comprises storing the hash value of the selected group of data items with the transaction record.

5. A method according to any of claims 3-4, wherein the transaction record is written to a provenance enabling system.

6. A method according to claim 5, wherein the provenance enabling system is a blockchain, such as a private blockchain replicated and/or distributed among trusted partners.

7. A method according to any of the preceding claims, wherein the method comprises receiving from the user a request for revocation of at least a part of the user-data consent, and revoking access to a corresponding part of data items.

8. A method according to any of the preceding claims, wherein the user-data consent is institution and data item specific, and wherein the selected group of data items is selected for each of the one or more institutions or for each group of the one or more institutions.

9. A method according to any of the preceding claims, wherein the user-data consent is a time limited consent, and wherein grant of access is automatically revoked upon expiry of the time limited consent.

10. A method according to any of the preceding claims, further comprising receiving a request from the user to withdraw a user-data consent; and in response to receiving the request withdraw the consent either immediately or upon approval of the request to withdraw the user-data consent.

11. A method according to any of the preceding claims, wherein the verified digital identity is a verified digital legal identity.

12. A method according to any of the preceding claims, wherein the verified digital identity comprises data item legal confirmations and/or data item legal proofs, the data item legal confirmations and/or the data item legal proofs including certification that required data item verification processes have been performed.

13. A method according to any of the preceding claims, wherein managing a verified digital identity of a user further comprises receiving from the user additional user data, the additional user data being stored as new verified data items, the additional user data being stored as updated verified data items replacing previous verified data items, the additional user data being corrected user data replacing previous data items stored but not certified as verified data items.

14. A method according to claim 13, wherein in response to receiving additional user data, processing the additional user data for verification, and in accordance with a determination that the additional user data can be certified as verified user data, storing the verified user data as verified data items.

15. A method according to claim 14, wherein processing the additional user data for verification comprises sending a request for verification of the additional user data and obtaining verification of the user data.

16. A method according to claim 15, wherein the request for verification of the additional user data and the verification of user data is obtained from a third party verification service company.

17. A method according to any of the preceding claims, wherein the one or more institutions provides access to a web interface for the user, and wherein the web interface enables the user to manage the verified digital identity of the user including providing consent to user-data and uploading of user data, including additional user data.

18. A method according to claim 17, wherein the web interface is a web interface of the one or more institutions, or wherein the web interface is a web interface module for integration with a web interface of the one or more institutions.

19. A method according to any of the preceding claims, wherein the verified digital identity is used in a cryptocurrency transaction and wherein the verified digital identity or selected data items of the verified digital identity is used as proof of identity for the cryptocurrency transaction, and wherein only the hash value of the verified digital identity or of the selected data items of the verified digital identity is recorded with the transaction.

20. A method according to any of the preceding claims, wherein managing a verified digital identity of a user further comprises receiving from the user a request for deletion or amendment of a data item, and wherein
in accordance with a determination that the data item does not form part of a selected group of data items for which grant of access has been provided, fulfil the request, and
in accordance with a determination that the data item forms part of a selected group of data items for which grant of access has been provided, deny the request.

21. A method according to any of the preceding claims, wherein the method comprises upon receiving a user-data consent from the user and providing access for the first institution to the selected group of data, enabling the first institution to re-share at least a part of the selected group of data to further institutions.

22. A method for onboarding users, wherein the method comprises managing a verified digital identity of a user by the method according to any of claims 1 to 20.

23. A system for managing a verified digital identity of a user, the system comprising:
a client terminal;
processor;
a computer readable storage medium storing:
a verified digital identity for a user, the digital identity comprising user-data stored as data items; wherein each data item is certified as a verified data item,
user-data consents; and
a computer program product comprising instructions which when executed by the processor:
receiving a user-data consent from the user to enable one or more institutions, including a first institution, access to a selected group of the data items;
receiving a user-data request from the first institution requesting access to user data from the digital identity,
determining whether the first institution's request matches the user-data consent for enabling access to the selected group of data items,
in accordance with a determination that the institution's user-data request matches the user-data consent for enabling access to the data items, granting the user data request, and
providing access for the first institution to the selected group of data items.

24. A method according to claim 23, wherein a record of each transaction is stored in the computer readable storage medium, each transaction being of a transaction type selected from the group of the following transaction types: user-data consent, grant of access, revocation of consents, deletion of consents, requests for deletion, request for user-data, request for verification of data, request for access, deletion, response of verification of data, re-sharing of data.

25. A method according to claim 24, wherein the selected group of data items are determined based on the transaction type and wherein a hash value is determined for the selected group of data items and stored with the selected group of data items with the transaction record.

26. The system according to claim 25, wherein the computer program product comprises instructions receiving from the user a request for revocation of at least a part of the user-data consent, and revoking access to a corresponding part of data items.

27. The system according to claim 25 or 26, wherein the computer program product comprises instructions for processing additional user data for verification, the instructions comprises sending a request for verification of the additional user data, obtaining verification of the user data, and storing the obtained verification of user data on the computer readable medium.
